(19) United States
(12) Patent Application Publication
(10) Pub. No.: US 2026/0342805 A1
(43) Pub. Date: Oct. 29, 2026

(54) Method and Apparatus For Providing or Receiving Information For Accessing an Object

(71) Applicant: Bayerische Motoren Werke Aktiengesellschaft, Muenchen (DE)

(72) Inventors: Alaa Mourad, Muenchen (DE); Lukas Ruemmelein, Hunderdorf (DE)

(21) Appl. No.: 19/106,177

(22) PCT Filed: Apr. 20, 2023
(86) PCT No.: PCT/EP2023/060223

§ 371 Date: Feb. 24, 2025

(30) Foreign Application Priority Data
Sep. 28, 2022 (DE) 10 2022 124 892.5

(51) Int. Cl. H04L 9/40

(52) U.S. Cl. CPC H04L 63/107

(57) ABSTRACT

A method grants access to an object among users of the object. The method includes obtaining information about a position of the object. There is a recipient of information for access to the object. The method further includes transferring the information about the position of the object to the recipient of information for access to the object.

The present application is the U.S. national phase of PCT Application PCT/EP2023/060223 filed on Apr. 20, 2023, which claims priority of German patent application No. 10 2022 124 892.5 filed on Sep. 28, 2022, the entire contents of which are incorporated herein by reference.

### TECHNICAL FIELD

Exemplary embodiments of the present disclosure relate to granting access to an object among users of the object. In particular, but not exclusively, exemplary embodiments of the present disclosure relate to applications for a vehicle.

### BACKGROUND

The application of digital approaches to providing access to vehicles is playing an increasingly important role in the automotive sector. It may be provided that access to a vehicle is shared by one user with another user, which is also known as “friend key sharing”. In this approach, a first user, such as a vehicle owner, can grant access to the vehicle to any other user, such as a friend, parking service employee, or any other person. The other user can then activate or obtain a corresponding vehicle key as they approach the vehicle in order to gain access. In some cases, however, the other user does not know where the vehicle is located, which makes it difficult to locate the vehicle. In practice, the other user is then, for example, forced to search for the vehicle or to inquire about the location of the vehicle. The same may apply to approaches to access to other objects, such as real estate properties.

There is therefore a need for an improved approach to granting access to an object among users of the object.

### SUMMARY

The exemplary methods and apparatus disclosed herein take account of this need.

Exemplary embodiments of the present disclosure are based on the finding that it is helpful in finding a (third-party) vehicle or other object if its position is known. Exemplary embodiments are therefore based on the idea that a recipient of information for access to an object, i.e., for example, a digital vehicle key or invitation to obtain such a key for access to a vehicle, also receives information about the position of the object in question (vehicle). In particular, it is proposed to transfer the vehicle key or the invitation together with information about the position of the vehicle. A person skilled in the art will appreciate that the information may contain geographic coordinates, an address or other position information to indicate the position of the vehicle.

Exemplary embodiments provide a method for granting access to an object among users of the object. The method comprises obtaining information about the position of the object and transferring the information about the position of the object to a recipient of information for access. This can make it easier for the recipient to locate the object, which can simplify access to the object as a whole.

The information for access, also to be understood as access information, can include any information that can be used to gain access to the object, for example to unlock or open the object. The access information may include a key for accessing the object or an invitation to obtain the key.

In some exemplary embodiments, the information about the position comprises information about a current location of the object. It may also be provided that the information about the position of the vehicle is updated. In this respect, the method may provide first information about a first position of the vehicle 330 to be transferred to the recipient at a first time and second information about a second position of the vehicle to be transferred to the recipient at a later, second time. In particular, this may facilitate access to mobile objects, which can change their location.

The information about the position may include or indicate/specify an address, a user input, position data of a satellite-based positioning system and/or geographical coordinates that indicate the position of the object. The address or the user input can be particularly useful for communicating the position of the object to a human user. On the other hand, the position data and the geographical data can be particularly useful for communicating the position of the object to devices.

In practice, the transfer of information about the position can be carried out by transferring the information for access. As a result, the recipient can obtain knowledge about the position of the object immediately upon receipt of the information for access. As a person skilled in the art who will benefit from the present disclosure will appreciate, this may also save communication resources compared to a separate transmission of the information.

In some exemplary embodiments, obtaining the information about the position involves receiving the information about the position from the object. In use cases that already provide for the object to determine its position, this can obviate the need for a repeated position determination.

Alternatively or in addition, obtaining the information about the position may include obtaining a user input to indicate the position. This allows the localization of the object, for example, even if a satellite-based determination of the position is not possible, e.g. in case of insufficient satellite reception in buildings, underground garages or the like.

As a person skilled in the art will appreciate, the method can be flexibly adapted to a desired use case. In particular, the method can be carried out by any type of device that is involved in providing the access. In practice, the method can be carried out, for example, by a terminal separate from the object or by a separate server.

Depending on the application, the method may also provide for the transfer of the information for access to the relevant recipient.

In some use cases, the object may comprise a vehicle or a (real estate) property.

A person skilled in the art will understand that the proposed method for providing the information for access can be applied in practice in conjunction with a (coherent) method for the recipient.

Accordingly, exemplary embodiments provide a method for a recipient of information for access to an object and for granting access to an object among users of the object. The method comprises receiving the information for access to the object and receiving information about a position of the object. This allows the recipient to locate the object more easily, thus simplifying access to the object.

For this purpose, the method may also provide for displaying the information about the position of the object. This allows the position of the object to be communicated to a human user in order to make it easier for them to locate the object.

The method may also include navigating based on the information about the position of the object. This can make it even easier for the user to locate the object.

Further exemplary embodiments provide a computer program comprising commands which, when the program is executed by a computer, cause said computer to execute one of the methods proposed herein. Accordingly, exemplary embodiments of the proposed methods may be implemented in each case as a computer-implemented method.

Exemplary embodiments provide a device for granting access to an object among users of the object. The device comprises one or more interfaces for communication and a data processing circuit which is configured to carry out one of the methods proposed herein using one or more interfaces.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a flowchart for schematically illustrating an exemplary embodiment of a method for granting access to an object among users of the object;

FIG. 2 shows a flowchart for schematically illustrating an exemplary embodiment of a method for a recipient of information for access to an object and for granting access to an object among users of the object; and

FIG. 3 shows a block diagram for schematically illustrating an application example; and

FIG. 4 shows a block diagram for schematically illustrating a device according to the proposed concept.

### DETAILED DESCRIPTION

Various exemplary embodiments will now be described in more detail with reference to the accompanying drawings, in which several exemplary embodiments are shown. In the figures, the thickness dimensions of lines, layers and/or regions are shown exaggerated for the sake of clarity.

“Friend key sharing” allows users of a vehicle to “share” access to the vehicle. For this purpose, a first user, e.g. an authorized vehicle owner, transfers an invitation to a second, different user, e.g. a friend or parking service employee, who is to be given access to the vehicle and can obtain a corresponding digital vehicle key with the invitation. The problem with this is often that the other user does not know where the vehicle is. The same applies to other applications of digital key systems-for example, to applications relating to properties that can be opened and/or locked with a digital key.

There is therefore a need for an improved approach to granting access to an object among users of the object.

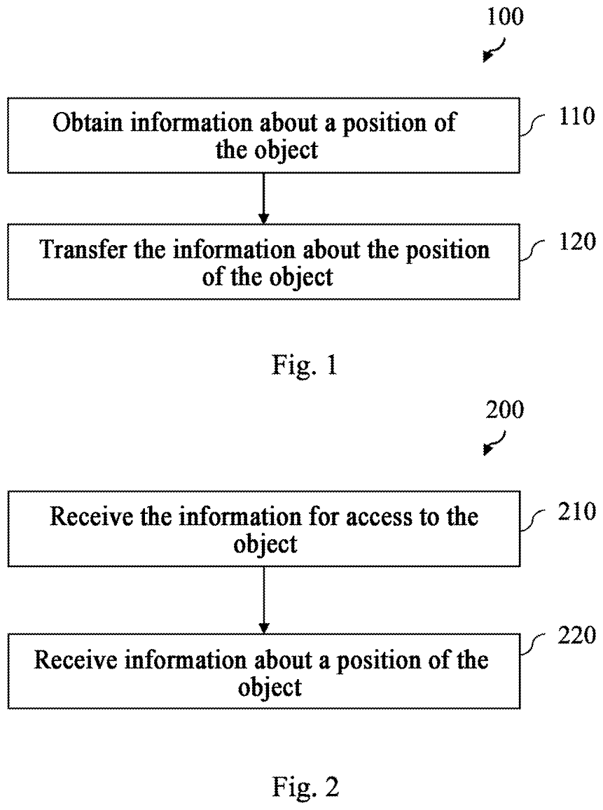

FIG. 1 illustrates a schematic representation of an exemplary embodiment of a method 100 for granting access to an object among users of the object. The object can be any object that can be secured, disabled, locked or opened with a digital key. In some use cases, the object is, for example, a vehicle or a property. The vehicle may be any ground-based vehicle, aircraft or watercraft. The property in some use cases can be any premises, in particular a building, an apartment or a holiday apartment. As a person skilled in the art will appreciate, the proposed concept is equally applicable to different objects. In this respect, explanations with regard to application examples in which the object corresponds to a vehicle can also be applied to other objects. Users can be any persons who (will) use the object as intended. In vehicle applications, the users can be, e.g. drivers of the vehicle. In real estate applications, the users can be residents or guests.

As shown, the method 100 comprises obtaining 110 information about a position of the object. In the context of the present disclosure, information about the position of the object may be understood to mean any (digital) data that is useful for indicating the position of the object. In some application examples, the object can provide a determination of its own position/self-location. In this case, the information about the position can be received from the object, for example. Optionally, the information about the position can be obtained based on user input.

For example, a vehicle can be already equipped with a positioning system, for example GPS (Global Positioning System), which is used to determine the position of the vehicle. In this case, positioning data can be obtained from the positioning system to obtain the information about the position of the vehicle.

Furthermore, the method 100 comprises transferring 120 the information about the position of the object to a recipient of information for access. In practice, the recipient can be a user who is granted access to the object by an appropriately authorized user of the object. The information for access (access information) comprises, for example, a digital key for the object or an invitation to obtain such a key or access to the object. The access information can be transferred directly by the authorized user or, at the request of the authorized user, by a server used for administration of the access information.

A person skilled in the art who benefits from the present disclosure will appreciate that the method 100 can be executed by any item of “user equipment”, e.g. a mobile phone, a computer, a tablet or similar, or a server for the object. In the context of this disclosure, method steps carried out by one of the users according to the wording of this disclosure may be understood as method steps of the respective user equipment.

In practice, the method 100 is carried out, for example, on/by user equipment of a user who has access to the object and/or is authorized to control access to the object by users. The authorized user is, for example, a vehicle owner of the vehicle, who has access to the vehicle him/herself, or an owner of the property. For some applications, this concept can therefore also be understood as a concept for “sharing” access to the object.

In order to provide the access information to another user, the authorized user may provide the access information to the other (second) user. For this purpose, the authorized user can, for example, arrange for an external server, for example a vehicle backend, (by means of its user equipment) to provide the access information and communicate it to the other user or their user equipment. Optionally, the access information can be provided by the user equipment of the authorized user and transferred to the other user or their user equipment.

Information about the position of the vehicle is obtained by the user equipment of the authorized user, for example (at least partially) from the vehicle or the vehicle backend. In addition or alternatively, information about the position can be obtained by means of a user input. The information about the position can be used to determine the information about the position. The information about the position contains, for example, information about geographical coordinates, an address, GPS data and/or a user input that indicates the position of the vehicle. The geographical coordinates and/or GPS data can be determined, for example, by means of satellite-based positioning using a locating system/positioning system which is installed in the vehicle. In practice, the locating system/positioning system can also be used in particular to navigate the vehicle.

In some environments, such as buildings or parking garages, satellite-based vehicle positioning may fail. In this case, the information can be determined by means of a user input.

The information about the position can be transferred by means of a network and/or internet connection from the user equipment of the authorized user to the user equipment of the recipient of the access information. The person skilled in the art will appreciate that the information about the position of the vehicle can optionally be transferred via/by means of the vehicle backend.

Optionally, the information about the position can be transferred together with the access information. In practice, the information about the position can be transferred, for example, together with the invitation by means of which the recipient can obtain a vehicle key for access to the vehicle. For the joint transfer of the information items, these can be transmitted together, for example, by means of a common data packet containing both the access information and the information about the position of the vehicle.

Information about the position makes it easier for the recipient to find the vehicle and gain access to the vehicle.

In some use cases, the method 100 can be carried out by an external server, such as the vehicle backend. Explanations in connection with the execution of the method 100 by user equipment can be transferred analogously to the execution by an external server.

In particular in the case of vehicles or other mobile objects, the position of the object may change. To prevent the recipient from being misdirected based on outdated information about the position of the object, the position of the vehicle can be determined repeatedly and the information about the position can be updated based on it. Accordingly, the recipient can then be supplied with the updated information about the position. The information about the position can therefore include information about a current position and/or a current location of the vehicle.

In practice, in addition to the method 100, a method for the recipient of the access information can be carried out, as is explained in more detail below with reference to FIG. 2. In view of the relationship between the methods, explanations relating to features and aspects of one of the methods may also apply mutatis mutandis to analogous features or aspects of the respective other method.

FIG. 2 shows a flowchart for schematically illustrating an exemplary embodiment of a method 200 for a recipient of information for access to an object, and for granting access to an object among users of the object. For example, the recipient is a friend or any other person who is to be granted access to the object.

The method 200 comprises receiving 210 the information for access to the object and receiving 220 information about a position of the object.

As already mentioned, the information about the position allows the recipient to locate the object more easily and thus provides them with easier access. According to the explanations for the method 100, the object is, for example, a vehicle.

To facilitate the locating of the vehicle, the position can be displayed based on the relevant information, for example, by means of the recipient's user equipment. For example, the position of the vehicle can be displayed on a digital map. In addition or alternatively, the address/postal address at which the vehicle is located can be displayed.

Alternatively or additionally, the method 200 also includes navigating based on the information about the position of the object. The recipient can be guided to the position of the object/vehicle based on direction and/or route information. The direction and route information can be given via acoustic and/or visual signals.

Using the information for access, the recipient can gain access to the located vehicle. In the event that the information for access contains a corresponding digital key, the recipient can, for example, use this to gain access. In the event that the information for access contains an invitation to obtain such a digital key, the recipient may first obtain the digital key by using the invitation and then use it to gain access. The recipient can obtain the digital key from the external server for verification, for example by submitting the invitation to an external server, e.g. the vehicle backend.

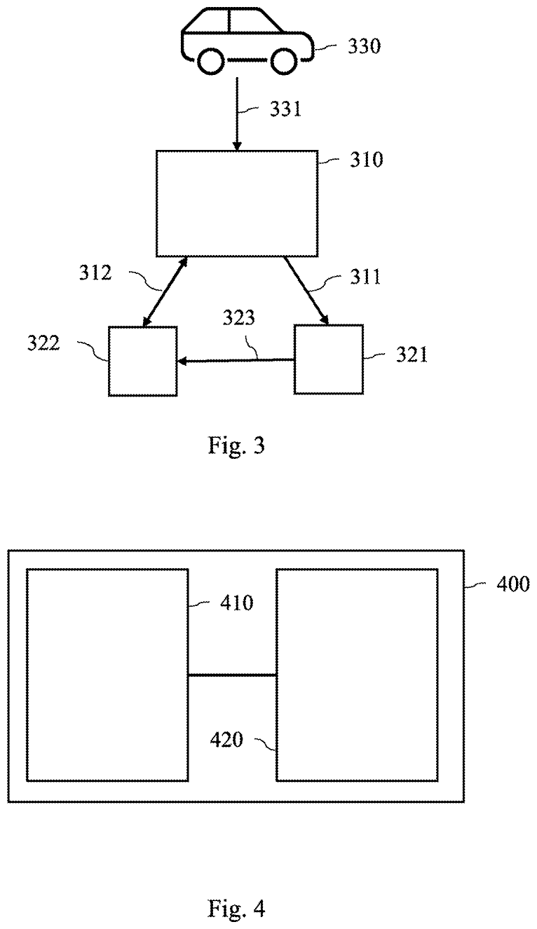

Further aspects and features of the proposed concept are explained in more detail with reference to FIG. 3 based on an exemplary use case. FIG. 3 shows a block diagram for schematically illustrating an application example.

According to the application example described here, first user is to grant access to a vehicle 330 to another, second user. Both the first user and the second user have user equipment for implementing the proposed concept. For example, in this case the first user has a first (mobile) terminal 321 and the second user has a second (mobile) terminal 322. In principle, however, any other user equipment can also be used in different use cases. Both the vehicle 330 and the terminals 321 and 322 are able to communicate with an external server, a vehicle backend 310.

In the present case, the first user is, for example, a vehicle owner of the vehicle 330. For access to the vehicle 330, the vehicle owner has a vehicle key stored on the first terminal 321 for unlocking and locking the vehicle 330.

In order to grant the other user access to the vehicle, the vehicle owner can use the first terminal 321 to provide the other user with access information, which enables the other user to gain access to the vehicle 330. In practice, the access information includes, for example, an invitation which allows the other user to obtain a vehicle key for the vehicle 330. In practice, the vehicle key can be obtained, for example, from the vehicle backend 310. For verification, the invitation can be generated based on the vehicle key of the vehicle owner and/or contain a digital signature of the vehicle owner or their terminal 321.

The invitation is transferred from the first terminal 321 to the second terminal 322, for example, via the Internet or another connection between the terminals 321 and 322. In practice, this can be carried out by means of a communication or messaging service. Optionally, this can be carried out via vehicle-specific or manufacturer-specific software and/or via the vehicle backend 310. Optionally, the invitation can also be issued by the vehicle backend 310 at the request of the vehicle owner.

In the present use case, for example, the other user does not know where the vehicle 330 is located, which may pose a problem for the other user in finding the vehicle 330.

In order to address this problem, it is proposed to additionally transfer information about the position of the vehicle 330 to the recipient of the access information. For this purpose, the terminal 321 obtains details of the position of the vehicle 330, for example, as indicated by arrow 311, from the vehicle backend 310. The details of the position contain, for example, GPS data of a positioning system (not shown) of the vehicle 330, which the vehicle 330, as indicated by arrow 331, transfers to the vehicle backend 310.

In some use cases, the information about the position of the vehicle 330 may already be available on the terminal 321 for a purpose other than that mentioned herein. In practice, the information about the position of the vehicle is used, for example, to locate and/or operate the vehicle 330 using the terminal 321 and a vehicle-or manufacturer-specific computer program provided for this purpose.

If satellite-based positioning of the vehicle 330 is not possible or fails, the vehicle owner may be prompted to obtain the information about the position to indicate the position of the vehicle by means of user input. Accordingly, the information about the position may comprise an appropriate user input.

The terminal 321 of the vehicle owner can then transfer the information about the position of the vehicle to the terminal 322 of the other user, as shown here schematically by arrow 323. This is transferred, for example, together with the invitation in order to obtain the vehicle key. The recipient can then submit the invitation to the vehicle backend 310 in order to prove to the vehicle backend that they are authorized for access to the vehicle 330 and then to receive a vehicle key for opening/closing the vehicle 330, as schematically illustrated by the double arrow 312.

Since the vehicle 330 can still change its position after receiving the information about the position, it is proposed to inform the other user about the position of the vehicle repeatedly from then on. For this purpose, the vehicle 330 can report (any) position changes to the vehicle backend 310 and based on this information the vehicle backend 310 can communicate updated information about the position of the vehicle or position changes to the other user or their terminal 322.

The terminal 322 can then display the position of the vehicle 330 to the recipient based on the information about the position or updated information about the position. For this purpose, the terminal 322 indicates to the recipient the address at which the vehicle 330 is located and/or the position at which the vehicle is located on a digital map of the surroundings.

Furthermore, the terminal 322 may use the information about the position for navigating the recipient, to guide the recipient to the vehicle 3330 using direction and/or route information.

The proposed approach can be applied in particular in the context of “friend key sharing”, i.e. to grant access to a vehicle among users. In principle, other applications can also be considered. For applications related to real estate properties, for example, the proposed concept can be used to grant access to guests of a rented holiday apartment.

It should be noted that the use case described here is only intended as an exemplary description of the present concept and that possible applications are in no way limited to the use case described.

In other exemplary use cases, method steps for obtaining and transferring the information about the position of the vehicle 330 and/or the access information (at the request of the vehicle owner) can be carried out by the vehicle backend 310.

Use cases may also relate to real estate properties or other objects, wherein aspects and features described in relation to the present use case are transferable mutatis mutandis to other use cases.

In some of the use cases, the proposed concept can also be applied by multiple users of the object and/or for access by multiple other users.

As the person skilled in the art who benefits from the present disclosure will appreciate, the proposed concept may be implemented in a computer program. Exemplary embodiments provide, for example, a computer program for implementing methods 100 or 200.

As explained in more detail in relation to FIG. 4, the proposed concept can optionally also be implemented in a device.

FIG. 4 shows a block diagram for schematically illustrating device 400 according to the proposed concept. As shown in the block diagram, the device 400 comprises one or more interfaces 410 for communication and a data processing circuit 420, which is configured to carry out one of the proposed methods (100, 200) using one or more interfaces 410.

The one or more interfaces can be interfaces for wired, contact-based or wireless/contactless transmission of information or data. In practice, the data processing circuit can comprise any programmable hardware component. Examples of such a programmable hardware component can be formed e.g. by a processor, a computer processor (CPU=Central Processing Unit), a graphics processor (GP =Graphics Processing Unit), a computer, a computer system, an application-specific integrated circuit (ASIC), an integrated circuit (IC), a single-chip system (SOC=System-on-Chip), a programmable logic element or a field-programmable gate array (FPGA) with a microprocessor.

For carrying out the proposed methods, the data processing circuit may be designed to execute a corresponding computer program. For this purpose, the computer program can be available on a (digital) storage medium and can be retrieved from it. The storage medium can therefore be machine-or computer-readable. Some exemplary embodiments thus comprise a data carrier, which has electronically readable control signals that are capable of interacting with programmable computer system or a programmable hardware component, in such a way that one of the methods described herein is carried out. One exemplary embodiment therefore is a data carrier (or a digital storage medium or a computer-readable medium), on which the program is recorded for carrying out one of the methods described herein.

In general, exemplary embodiments of the present disclosure can be implemented as software, firmware, computer program or computer program product with a program code or as data, wherein the program code is, or the data are, effective in terms of carrying out one of the methods if the program is running on a processor or a programmable hardware component. The program code or the data can also be stored, for example, on a machine-readable medium or data carrier. The program code or the data can exist in the form of source code, machine code or byte code, among other things, as well as other intermediate code.

The examples described above only represent an illustration of the principles of the present invention. It is implicit that modifications and variations of the arrangements and details described herein will be apparent to other persons skilled in the art. It is therefore intended that the invention be limited only by the scope of protection of the following patent claims and not by the specific details, which have been presented herein on the basis of the description and explanation of the exemplary embodiments.

### LIST OF REFERENCE SIGNS

100 method for granting access to an object among users of the object
110 obtaining information about a position of the object
120 transferring the information about the position of the object
200 method for a recipient of information for access to an object and for granting access to an object among users of the object
210 receiving the information for access to the object
220 receiving information about a position of the object
310 vehicle backend
311 arrow
312 double arrow
321 (mobile) terminal
322 (mobile) terminal
323 arrow
330 vehicle
331 arrow
400 device
410 one or more interfaces
420 data processing circuit

1.-14. (canceled)

15. A method for granting access to an object among users of the object, the method comprising:
obtaining information about a position of the object; and
transferring the information about the position of the object to a recipient of information for access to the object.

16. The method as claimed in claim 15, wherein the information for access comprises a key for access to the object or an invitation to obtain the key.

17. The method as claimed in claim 16, wherein transferring the information about the position of the object comprises transferring the information about the position of the object together with the information for access.

18. The method as claimed in claim 15, wherein the information about the position indicates at least one of the group consisting of:
an address that indicates the position of the object;
a user input that indicates the position of the object;
position data of a satellite-based positioning system that indicates the position of the object; and
geographical coordinates that indicate the position of the object.

19. The method as claimed in claim 18, wherein transferring the information about the position of the object comprises transferring the information about the position of the object together with the information for access.

20. The method as claimed in claim 18, wherein obtaining the information about the position comprises receiving the information about the position from the object.

21. The method as claimed in claim 15, wherein the information about the position comprises information about a current location of the object.

22. The method as claimed in claim 15, wherein transferring the information about the position of the object comprises transferring the information about the position of the object together with the information for access.

23. The method as claimed in claim 15, wherein obtaining the information about the position comprises receiving the information about the position from the object.

24. The method as claimed in claim 15, wherein obtaining the information about the position comprises obtaining a user input containing information specifying the position.

25. The method as claimed in claim 15, wherein the method is carried out by a terminal separate from the object.

26. The method as claimed in claim 15, wherein the method is carried out by a separate server.

27. The method as claimed in claim 15, wherein the object comprises a vehicle or a real-estate property.

28. A non-transitory computer storage medium having a computer program comprising commands which, during the execution of the computer program by a computer, cause said computer to carry out the method of claim 15.

29. A device for granting access to an object among users of the object, the device comprising:
one or more interfaces for communication; and
a data processing circuit configured to carry out the method as claimed in claim 15 using the one or more interfaces.

30. A method for a recipient of information for accessing an object and for granting access to an object among users of the object, the method comprising:
receiving the information for access to the object; and
receiving information about a position of the object.

31. The method as claimed in claim 30, further comprising displaying the information about the position of the object.

32. The method as claimed in claim 30, further comprising performing navigation based on the information about the position of the object.

33. A non-transitory computer storage medium having a computer program comprising commands which, during the execution of the computer program by a computer, cause said computer to carry out the method of claim 30.

34. A device for granting access to an object among users of the object, the device comprising:
one or more interfaces for communication; and
a data processing circuit configured to carry out the method as claimed in claim 30 using the one or more interfaces.
